(19) United States
(12) Patent Application Publication
(10) Pub. No.: US 2005/0266946 A1
(43) Pub. Date: Dec. 1, 2005

(54) Two-shot unified chain tensioner arm or guide

(75) Inventors: Chris Thomas, Ithaca, NY (US); Scott Kobylarz, Ithaca, NY (US); Brad Adams, Homer, NY (US); Al Moster, Ithaca, NY (US); Sean Simmons, Cortland, NY (US)

Correspondence Address: BORGWARNER INC., 3850 HAMLIN ROAD, AUBURN HILLS, MI, 48326, US

(73) Assignee: BorgWarner Inc., Auburn Hills, MI (US)

(21) Appl. No.: 11/183,200

(22) Filed: Jul. 15, 2005

Related U.S. Application Data
(63) Continuation-in-part of application No. 10/423,574, filed on Apr. 25, 2003, now Pat. No. 6,939,259.

(51) Int. Cl. A23P 1/00

(52) U.S. Cl. 474/111

(57) ABSTRACT

A method molds a device, such as a chain tensioner arm including two elements, one structural and one wear-resisting, using a single forming device within a single molding cycle. The two elements are preferably then combined during the single molding cycle. The elements preferably include a structure element with a top surface spanning a first end and a second end of the structure element, the top surface having a predetermined thickness, and a wearing element having a first surface and a second surface, the first surface disposed to engage a chain, the second surface being physically interlocked with the top surface of the structure element with allowance for relative movement between the top surface of the structure element and the second surface of the wearing element.

### REFERENCE TO RELATED APPLICATIONS

This is a continuation-in-part of copending application Ser. No. 10/423,574, filed Apr. 25, 2003, entitled “TWO-SHOT UNIFIED CHAIN TENSIONER ARM OR GUIDE”. The aforementioned application is hereby incorporated herein by reference.

### BACKGROUND OF THE INVENTION

1. Field of the Invention

The invention pertains to the field of chain tensioners or guides. More particularly, the invention pertains to a two-shot unified chain tensioner arm or guide.

2. Description of Related Art

Chain tensioner arms and guides are known to be used in internal combustion engines. In a typical engine with one or more overhead camshafts, it is essential to incorporate in the timing chain system guiding and tensioning elements to ensure that chain tension is maintained within acceptable limits to avoid chain failure or shaft overloading.

Because these guiding elements are in continuous contact with the moving chain, the elements have frictional characteristics and need wear-resistance. Additionally because in some instances the contact forces between the chain and the guide or tensioner arm can be substantial, they must possess substantial structural strength to withstand these contact forces.

Typically one of the contact element material solutions involves using a PA 6/6 or PA 4/6 type surface because of its superior friction, wear, and high temperature characteristics. However this material does not have the structural integrity to handle forces transmitted from the chain to the guiding system components or the forces applied from the tensioner arm to the chain. A common solution to this issue is to have a metallic or fiber reinforced plastic structural member—cast iron, die-cast aluminum, glass filled nylon or stamped steel—for supporting the nylon contact surface. This method requires assembling the structure or wear surface into a final part, or completely finishing the structure element and then inserting it in a mold, thereby producing the contact surface on top of the structure element. In either case, the dissimilarity of the materials results in some unique problems that are difficult to overcome because of the assembly process and dissimilar expansion characteristics of the materials involved. In addition, the cost of non-unified assemblies is relatively high due to the labor involved in the assembly process.

With regard to assembly issues, the problem of the mating elements becoming unattached from one another prior to assembly into the engine, or while in service, is a significant obstacle. Additionally because the materials are dissimilar, their expansion and contraction characteristics will differ, thereby at temperature extremes, special stresses may occur due to physical constraints. Alternatively, the interfaces between the materials become physically altered if one of the elements expands or contracts by an amount greater than the allowance given by its mating counterpart.

U.S. Pat. No. 4,832,664 teaches a guide rail for the guiding and/or tightening of chains that are used in internal-combustion engines, for example, for driving camshafts, auxiliaries or the like. For reasons concerning weight and manufacturing, the guide rail consists of a plastic material and is formed by a slideway lining body and a carrier. Both the carrier and the slideway lining body are produced in a progressive manufacturing cycle and are interconnected via one or several dovetailed connections.

However, the method of making this guide rail requires two separate steps of molding. The method requires removing the carrier parts from the mold after a first step. Then in a separate step, the slideway linings are molded over the carrier. Having the two separate steps has its disadvantages. These disadvantages include the need for two separate devices for forming each piece (such as two separate molding devices), and at least the need to remove the parts from the mold after the first step is required. A significant outlay of cost and space is required to make the tensioner arm or guide. In addition, the guide rail design precludes movement due to thermal expansion or contraction, thereby producing high stresses and deflections at the interface of the two elements.

U.S. Pat. No. 6,634,974 teaches joining a part or all of a joint portion between a sliding contact section and a reinforcement main body of a chain guide member by melting. However, the chain guide member still has differential expansion/contraction-induced stresses and deflections, which can cause debonding or other failure of the assembly.

Therefore, there is a need to combine the two molding steps using the same basic molding equipment and a special mold, which can produce the final product without the need to remove the parts from the mold after the first step. There is also a need for a design that allows and accommodates sliding movement between the two elements.

### SUMMARY OF THE INVENTION

The present invention produces tensioning and guiding components by means of a two-shot molding process using compatible materials.

A method of the present invention uses a single forming device to form at least two elements. The two elements are molded using the single forming device within a single molding cycle where the two elements are preferably mechanically interlocked together. The elements preferably include a structure element with a top surface spanning a first end and a second end of the structure element, the top surface having a predetermined thickness, and a wearing element having a first surface and a second surface, the first surface disposed to engage a chain, the second surface being physically interlocked with the top surface of the structure element with allowance for relative movement between the top surface of the structure element and the second surface of the wearing element.

In a preferred embodiment, the wearing element and the structure element do not bond during the molding step in a way that precludes relative movement between the wearing and structure elements. In this embodiment, a higher melting point material is preferably used for the element being produced during the first shot of the two-shot molding process than the material used for the element being produced during the second shot of the two-shot molding process. This avoids bonding of the structure element to the wearing element during molding, which may otherwise occur as a result of remelting of the surface of the first shot during second shot molding.

### BRIEF DESCRIPTION OF THE DRAWINGS

FIG. 1 shows a perspective view of the present invention with a two-shot molded part in which no component assembly is required other than the two-shot molding.

FIG. 1A shows a perspective view of the top portion of the wearing element of FIG. 1.

FIG. 1B shows a top perspective view of the present invention showing a top surface of the structure element of FIG. 1.

FIG. 2 shows a two-shot molded part of the present invention in which a combination of U and I beam construction is employed.

FIG. 2A shows a sectional view of A-A of FIGS. 1A and 2, in which the connection of a top, wearing portion with a bottom structure portion of the tensioner arm or guide is shown at the U-beam constructed section.

FIG. 2B shows a sectional view of A-A of FIGS. 1A and 2, in which the connection of a top, wearing portion with a bottom structure portion of the tensioner arm or guide is shown at the I-beam constructed section.

FIG. 3A shows a perspective view of a two-shot molded part interlock design of the present invention that accommodates and does not resist thermal expansion.

FIG. 3B shows a sectional cut view along B-B of FIG. 3A.

FIG. 3C shows an enlarged view of circle C of FIG. 3B.

FIG. 4 shows a flowchart of a method of the present invention.

### DETAILED DESCRIPTION OF THE INVENTION

The present invention produces tensioning and guiding components by means of a two-shot molding process using compatible materials. Two-shot injection molding manufactures a part, for example a tensioning device, in a single tool using sequential injection molding processes. The materials are molded using the same basic molding equipment and a special mold, which can produce the final product without the need to remove the parts from the mold after the first step. The resulting tensioning and guiding components provide adequate structural integrity, while minimizing cost and space.

There are three major types of bonding: thermal, chemical, and physical/mechanical bonding. Thermal bonding bonds two elements through the use of heat energy to melt, exchange material across part boundaries, and resolidify. Chemical bonding (which includes, for example, adhesive bonding through the use of thermoplastic adhesives), bonds two elements through the use of chemical reactions. Physical/mechanical bonding is any other bonding, for example, an interlock between two elements.

In the present invention, thermal bonding of a wearing element to a structure element of a device, such as a tensioner or a chain guide, is prevented by using materials with dissimilar melting points for the wearing element and the structure element. The higher melting point material is chosen for the element which is molded in the first shot of a two-shot molding process. In one embodiment, the material of the structure element has a higher melting point than the material of the wearing element. In another embodiment, the material of the wearing element has a higher melting point than the material of the structure element. Thus, the wearing element is prevented from bonding to the structure element even when the time interval between the injection of the structure element and the wearing element is very short. The present invention eliminates thermal bonding entirely.

In one embodiment of the present invention, a structure element is made of polyamide 4/6 (PA 4/6), while a wearing element is made of polyamide 6/6 (PA 6/6). These elements are molded together using a two-shot injection molding process. The wearing element (face) is retained on the structure element solely by mechanical interlocks. The interlocks are designed to allow the wearing element to freely expand or contract when acted upon by thermal forces. There is only physical bonding through the interlocks; there is no thermal bonding that prevents expansion or contraction due to thermal forces. In addition, there is preferably no chemical bonding, which would impede slidability of the elements.

The present invention also provides a means of dealing with differential thermal expansion between the filled and unfilled members whereby internal stresses that may cause distortion (e.g. creep) or structural failure would not be induced.

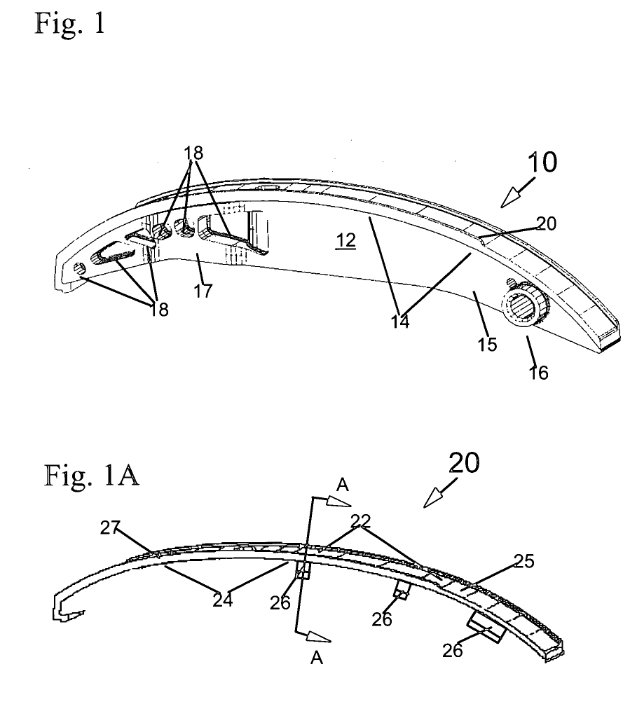

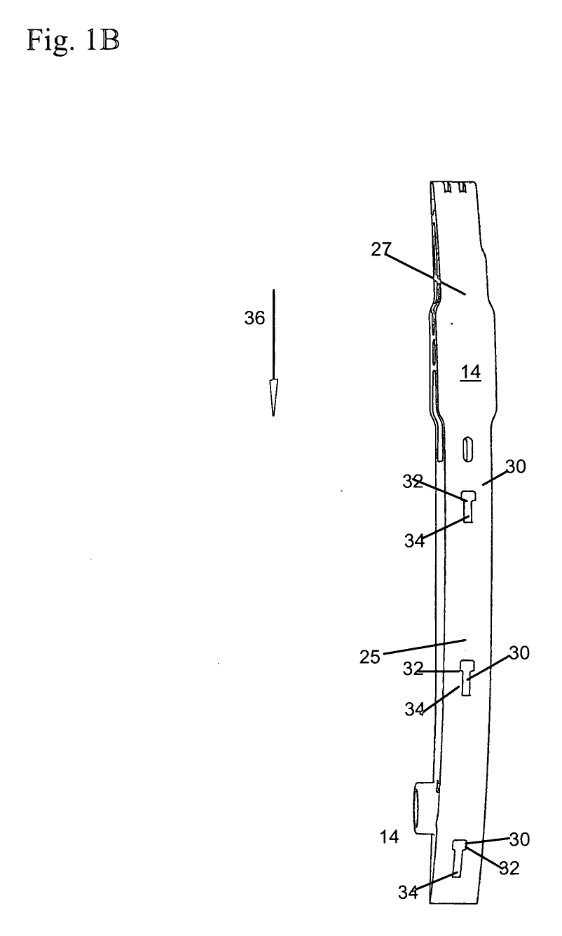

Referring to FIG. 1, a two-shot molded part 10 in which no component assembly is required is shown. A structure element 12 forms the base of the two-shot molded part 10. Structure element 12 has a generally elongated shape and includes a top wearing surface 14 along the longitudinal length of the structure element 12. Structure element 12 may be made of glass-filled plastic or any polymer structure (be it filled or unfilled). A connecting member 16 having an annular opening for pivotal coupling to a stationary member (not shown), which is stationary in relation to the chain, is provided at a first end 15 of structure element 12. A suitable connecting member (not shown) such as a bolt or dowel pin may be transposed through connecting member 16 for coupling to the stationary member. Along a second end 17 of structure element 12, recesses 18 are formed on both sides of the structure element 12 (only one side shown). Although a pivoting tensioner is described in the figures, a wearing element and a structure element for use as a fixed tensioner or guide may alternatively be made by the two-shot molding process of the present invention.

A wearing element 20 formed of a material having more elasticity or less rigidity as compared with structure element 12 is provided. Both members of the tensioner arm, i.e., structure element 12 and wearing element 20, are molded in a single cycle using the same molding tool. Wearing element 20 may be made of a polymer material such as plastic without reinforcement. Wearing element 20 has a shape that traces or follows the generally elongated shape of structure element 12. Wearing element 20 further includes a first surface 22 and a second surface 24. First surface 22 is disposed to be in contact with a chain (not shown) thereby keeping the chain at a suitable tension. Second surface 24 is disposed to be in physical contact with top surface 14 of structure element 12. There is preferably no chemical or thermal bonding between wearing element 20 and structure element 12 even if both elements (12, 20) are made of polymer materials. Wearing element 20 is divided into a first end 25 and a second end 27. First end 25 structurally corresponds to the first end 15 of wearing element 20. Second end 27 structurally corresponds to the second end 17 of wearing element 20.

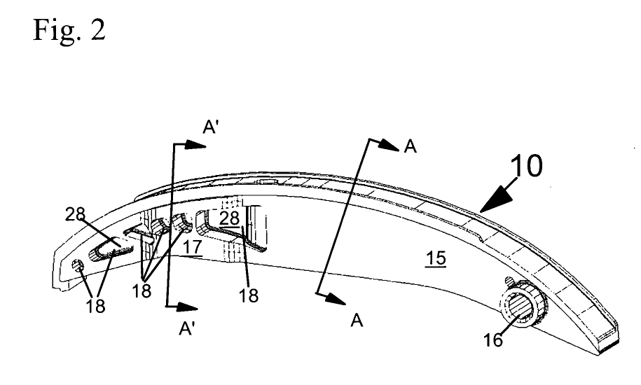

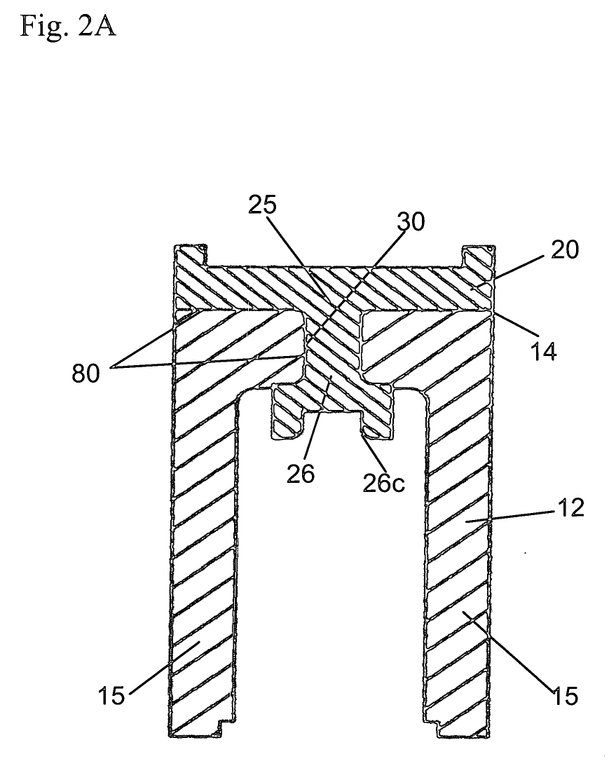

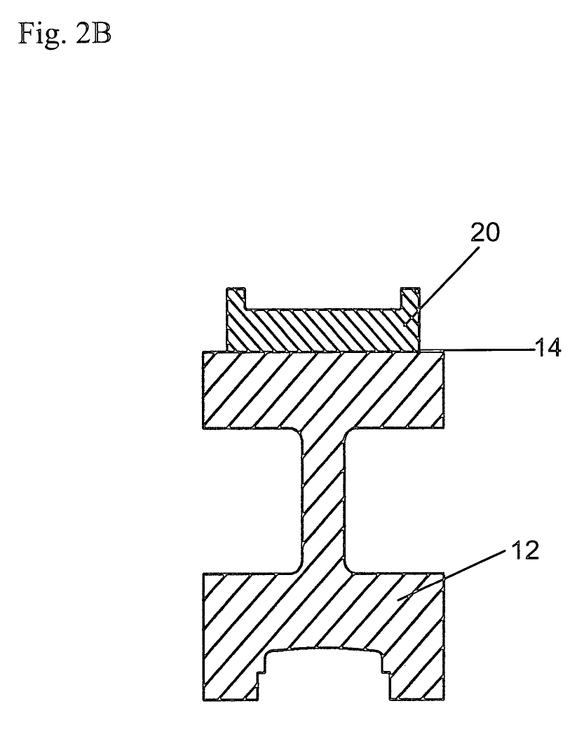

A set of connecting elements 26 is formed on the first end 15 of wearing element 20. Elements 26 protrude from second surface 24 for extending through openings 30 formed on top surface 14 (refer to FIG. 1B). It is noted that top surface 14 possesses a suitable thickness for connecting elements 26 to extend completely therethrough and may permit a top portion (see FIG. 2A) to physically affix wearing element 20 and structure element 12 together.

Referring to FIG. 1B, a top perspective view of the present invention where the top surface 14 of the structure element 12 of FIG. 1 is shown. Openings 30 include an entering portion or region 32 and a locking portion or region 34. Entering portion 32 is provided for the initial entering of connecting elements 26, where the top portion extends completely through opening 30. After the top portion completes the extension, a sideways movement along arrow 36 is performed whereby the top portion of connecting elements 26 move into the locking region 34.

As can be appreciated, relative physical movements between wearing element 20 and structure element 12 are permitted due to the size difference between connecting elements 26 and openings 30.

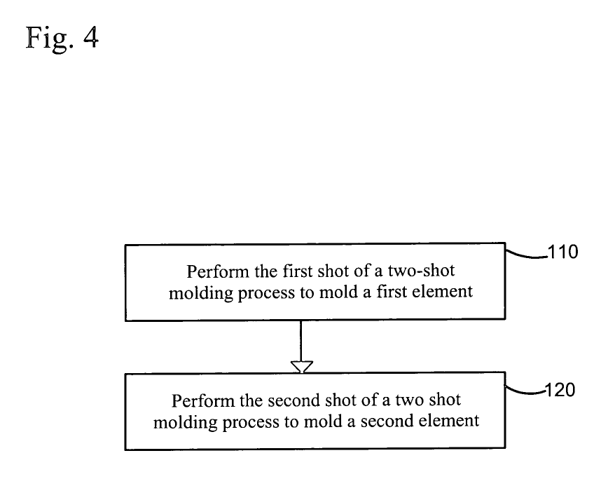

FIG. 4 shows a flowchart of a method of the present invention. The two-shot molding process begins with a single forming device, or molding tool, for molding two elements. In one embodiment, the two elements are preferably a structure element 12 and a wearing element 20, as shown in the figures. A first element is molded during a first shot of the two-shot molding process in step 110. This step occurs at a temperature higher than the melting point of the material of which the first element is made. The first element is preferably then cooled to a temperature below the melting point of the first element so that the first element becomes at least partially cured, or solid.

The first element and the second element are made of materials with dissimilar melting points. More specifically, the second element is preferably made of a lower melting point material than the first element. In one preferred embodiment, the second element is made of a material with a melting point at least 20° C. less than the melting point of the material of which the first element is made.

In step 120, the second shot of the two-shot molding process, the second element is molded at a temperature above the melting point of the material of which the second element is made while the surfaces 80 contacting the first shot element are kept at temperatures below the melting point of the material of which the first element is made. In other words, the temperature at the surfaces 80 where the second element contacts the first element is kept below the melting point of the first element, so that the first element does not melt or bond with the second element during the second shot of the two-shot molding process.

These surfaces 80 are cooled, preferably by cooling water traveling through the forming device, to take heat energy out of the second shot step. If the first element was made of a material with the same or lower melting point as the second element, it would not be possible to cool the device fast enough to keep the first element from melting. However, since the first element has a higher melting point than the second element, cooling prevents the first element from remelting during the second shot of the two-shot molding process. The second element solidifies when the device is cooled to a temperature below the melting point of the second element.

Due to the dissimilar melting points, the first element and the second element do not thermally bond during step 120. In addition, there is preferably no other bonding (such as chemical bonding) that would preclude a device made of the two elements from expanding or contracting due to thermal forces.

The two elements are preferably combined by physical bonding, which permits movement between the elements. For example, in the tensioners discussed herein, the physical bond is the interlocking between the connecting elements 26 on the wearing element 20 and the openings 30 formed on the structure element 12 (see FIG. 1B).

In one example, the structure element 12 is molded during the first shot of the two-shot molding process. In this example, the structure element 12 is made of a glass filled PA 4/6, which has a melting point of approximately 295° C. The wearing element 20, which is molded during the second step of the two-shot molding process, is made of an unfilled PA 6/6, which has a melting point of approximately 245° C.

The openings 30 of the structure element 12 are molded during the first shot of the process, along with the rest of the structure element 12. The wearing element 20, including the connecting elements 26, are molded during the second shot of the process. The melted material forming the connecting elements 26 travels through the openings 30 until they encounter tool steel that creates the shape of the bottom of the connecting elements 26. When the connecting elements 26 solidify, they are interlocked in the openings 30 (see FIG. 2A). As soon as the melted material injected during the second shot becomes solid, the structure element 12 and the wearing element 20 are interconnected.

The present invention teaches a tensioner arm and methods of producing tensioning arm and chain guiding components that provide adequate structural integrity while minimizing cost and space. In order to incorporate adequate strength and rigidity to the structural bracket element 12, the cross section of the structure element 12 is preferably in the form of an I-beam. However when attempting to mold an element in the shape of an I-beam, mold tooling actuation is such that only a limited number of elements can be molded at the same time thus rendering the process commercially less feasible. A more suitable design from a molding standpoint incorporates a U-shape bracket. However such a shape is not as strong as needed to withstand the stresses to which the part is ultimately subjected.

Referring back to FIGS. 1 and 1B, to overcome the aforementioned deficiencies, the present invention teaches a structure element 12 which incorporates a cross section that is partly I-beam and partly U-shaped. In other words, structure element 12 is a single physical member having a first end 15 that is U-shaped and a second end 17 that is an I-beam. By using the I-beam construction in the highly stressed area such as the second end 17 of structure element 12 and the U-shape in the lower stressed area of the bracket 12, the simultaneous molding of an adequate number of elements is possible (see FIG. 2).

The shape of the structure element 12 is not limited to a U-shape and an I-beam. Element 12 may be a combination of at least two of the following shapes: U-shaped, I-beam, H-beam, E-shaped, and other suitable structure formations.

Referring to FIG. 2, a pivoted tensioner 12 similar to the one shown in FIG. 1 is depicted. Tensioner 12 may be subdivided into two simultaneously formed structures. The first structure is the above described I-beam. As can be seen, the recesses 18 are formed on each side of the second end 17 (only one side shown). A center portion 28, which forms part of the structure of the second end 17, is also part of the I-beam. One reason for the I-beam structure is that for a pivotal chain tensioner, more structural integrity is required at the second end 17 as compared to the first end 15 of structure element 12. As can be appreciated, the location of the I-beam is determined by actual implementation of the present invention.

Although a pivoting chain tensioner arm is shown in the figures, the present invention also includes other types of chain tensioner arms (for example, fixed tensioner arms) and chain guides. Other tensioners and guides can be molded using the two-shot molding process with a special mold, which can produce the final product without the need to remove the parts from the mold after the first step.

Referring to FIG. 2A, a sectional view along A-A of FIGS. 1A and 2, in which the connection of a top portion with a bottom portion of the tensioner is shown. The top portion may be the wearing element 20. The bottom portion may be the structure element 12. At the U beam construction portion or first end 15, a U-shaped (or N-shaped for this particular depiction) structure is provided. First end 15 of structure element 12 corresponds to the first end 25 of wearing element 20. In the present sectional view, connecting elements 26 each have a tip 26c that extends completely past the top surface 14.

Referring to FIG. 2B, a sectional view along A′-A′ of Fig two is shown. In the present section, structure element 12 has the I-beam formation. Top surface 14 of structure element 12 is in close physical contact or physical bonding with a corresponding surface of wearing element 20. The two surfaces are preferably formed to be suitable for sliding, for example in a flat formation.

In a preferred embodiment, dissimilar melting point materials are used for the structure element 12 and the wearing element 20. The difference between the melting points is preferably greater than 20° C.

More specifically, a higher melt point material is preferably used for the element being molded during the first shot of the two-shot molding process, to avoid thermal or other bonding of the structure element 12 to the wearing element 20 during the two-shot molding process. The type of bonding that is avoided is any bonding that creates high stresses and deflections when the materials contract or expand. This includes thermal bonding and chemical bonding. Preventing these types of bonding permits greater slidability between the structure element 12 and the wearing element 20 in the resulting tensioner. Consequently, the only type of bonding that occurs is physical bonding.

Either element may be molded during the first shot of the molding process. For example, if the wearing element 20 is molded during the first shot of the two-shot molding process, and the structure element 12 is molding during the second shot of the two-shot molding process, the wearing element 20 is made of a higher melting point material than the structure element 12. Conversely, if the structure element 12 is molded during the first shot of the two-shot molding process, and the wearing element 20 is molding the second shot of the two-shot molding process, the structure element 12 is made of a higher melting point material than the wearing element 20.

The present invention also provides a means for dealing with differential thermal expansion between the filled and unfilled members whereby internal stresses that may cause distortion or structural failure would not be induced. Composite materials may be used for the members in alternative embodiments of the present invention.

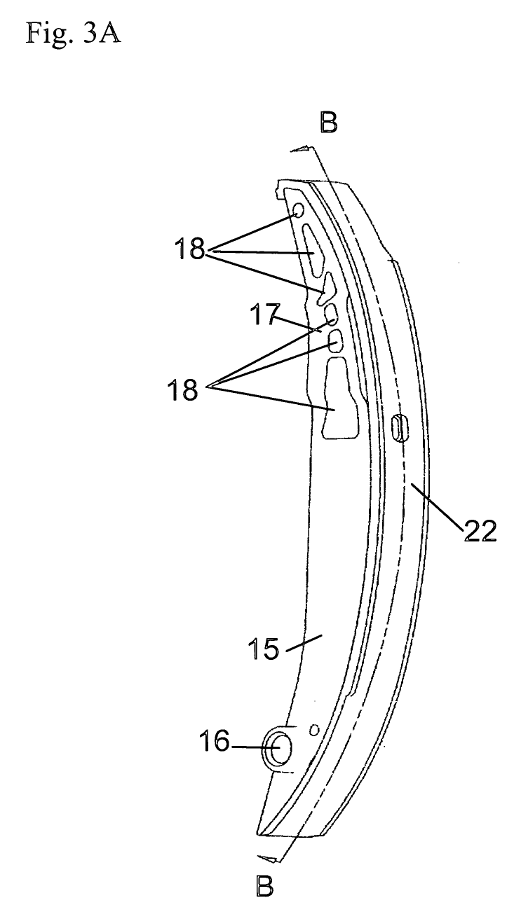

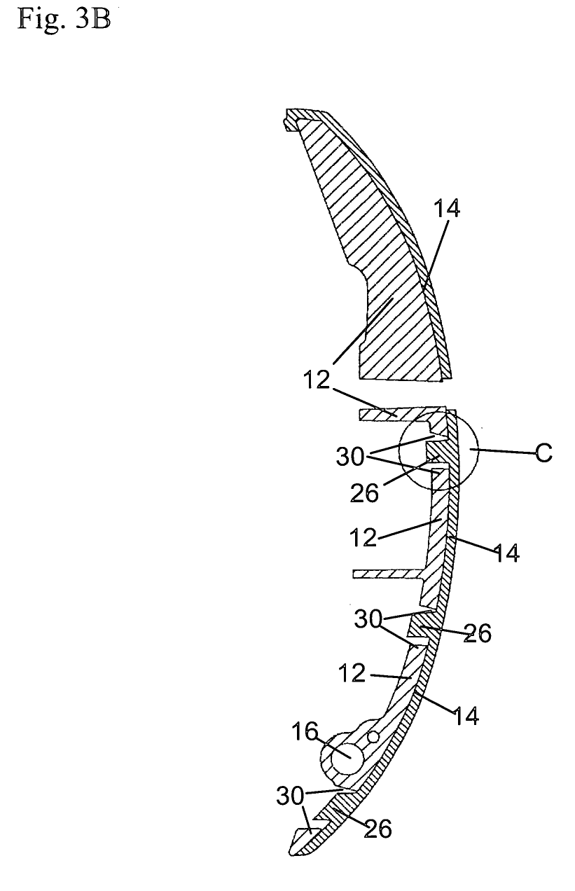

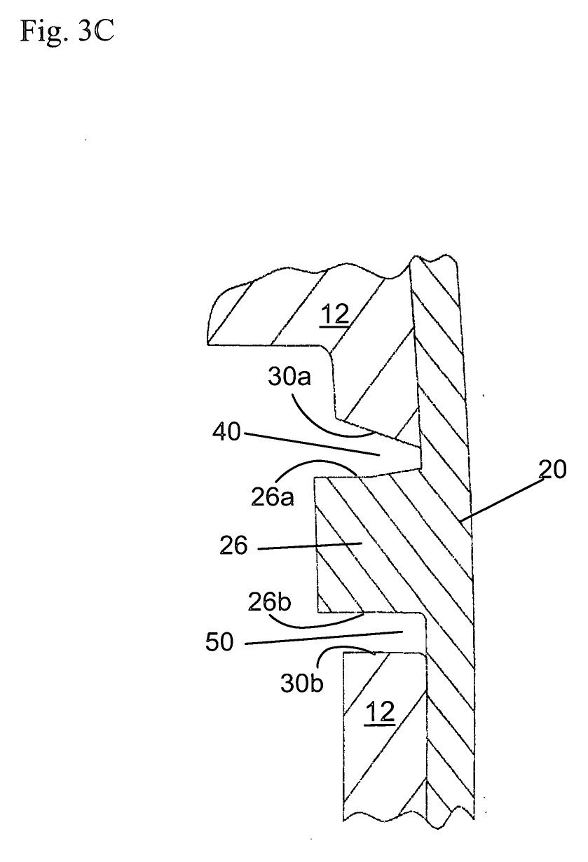

The interlock design shown in FIGS. 3A-3C provides clearances between elements of the first and second molding steps that are present under all temperature conditions, thus accommodating differential expansion and contraction without inducing stress on the elements.

FIG. 3A shows a perspective view of a two-shot molded part interlock design of the present invention that accommodates and does not resist thermal expansion. The reference numerals in FIG. 3A correspond to the same reference numerals in previous figures.

As can be appreciated, creep occurs in various materials and creep causes the shape of a member to change. In some embodiments of the present invention, the thermal characteristics between members are different. For example, structure element 12 and wearing element are different members having different thermal characteristics. If the two are subjected to engine operating conditions where temperature varies, it is desirable to reduce the creep effect. The following teaches a set of gaps 40, 50 for overcoming the creep effect.

Referring to FIG. 3B, a sectional cut view along B-B of FIG. 3A is shown. The reference numerals in FIG. 3B correspond to the reference numerals in previous figures.

Referring to 3C, an enlarged view of circle C of FIG. 3B is shown. Connecting element 26 of wearing element 20 extends through opening 30 of structure element 12. A first gap 40 is formed between a first surface 30a of opening 30 and a first end 26a of connecting element 26. A second gap 50 is formed between a second surface 30b of opening 30 and a second end 26b of connecting element 26. As can be seen, gaps 40 and 50 allow different thermal expansion or contraction between structure element 12 and wearing element 20. It is noted that there is no thermal or chemical bonding between structure element 12 and wearing element 20.

As can be seen from FIG. 3B, similar gaps are formed on the other two openings 30 and connecting elements 26.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A method for making a device using a single forming device to form at least two elements wherein the elements comprise a structure element comprising a top surface spanning a first end and a second end of the structure element, the top surface having a predetermined thickness; and a wearing element having a first surface and a second surface, the first surface disposed to engage a chain, the second surface being physically connected to the top surface of the structure element with allowance for relative movement between the top surface of the structure element and the second surface of the wearing element, comprising the step of:
a) molding the structure element and the wearing element using the single forming device within a single molding cycle;
wherein the wearing element and the structure element are interconnected but able to move with respect to each other in response to thermal expansion and contraction.

2. The method of claim 1, further comprising the step of:
b) combining the structure element with the wearing element during the single molding cycle.

3. The method of claim 2, wherein step b) includes extending a set of connecting elements of the wearing element completely through a set of openings of the structure element.

4. The method of claim 1, wherein the method uses injection molding and the structure elements and the wearing element comprise different polymer materials.

5. The method of claim 1, wherein the top surface of the structure element includes a plurality of openings disposed to receive a plurality of connecting elements of the wearing element, wherein the connecting elements protrude from the second surface of the wearing element and at least a portion of each of the connecting elements extend completely through the openings; and
wherein the openings are larger than the connecting elements thereby allowing for relative movement between the structure element and the wearing element.

6. The method of claim 1, wherein the device is a chain tensioner.

7. The method of claim 1, wherein the device is a chain guide.

8. The method of claim 1, wherein the structure element and the wearing element are not thermally bonded to each other.

9. The method of claim 1, wherein the structure element and the wearing element are not chemically bonded to each other.

10. The method of claim 1, wherein there is slidability between the structure element and the wearing element.

11. The method of claim 1, wherein the structure element is made of a higher melting point material than the wearing element.

12. The method of claim 11, wherein the structure element is molded in a first substep of the single molding cycle, and the wearing element is molded in a second substep of the single molding cycle, wherein the second substep occurs after the first substep.

13. The method of claim 1, wherein the wearing element is made of a higher melting point material than the structure element.

14. The method of claim 13, wherein the wearing element is molded in a first substep of the single molding cycle, and the structure element is molded in a second substep of the single molding cycle, wherein the second substep occurs after the first substep.

15. A method for making a device using a single forming device to form at least two elements wherein the elements comprise a structure element comprising a top surface spanning a first end and a second end of the structure element, the top surface having a predetermined thickness; and a wearing element having a first surface and a second surface, the first surface disposed to engage a chain, the second surface being physically bonded with the top surface of the structure element with allowance for relative movement between the top surface of the structure element and the second surface of the wearing element, comprising the steps of:
a) molding the structure element and the wearing element using the single forming device during a single molding cycle; and
b) extending a set of connecting elements of the wearing element completely through a set of openings of the structure element during the single molding cycle.

16. The method of claim 15, wherein the structure element is made of a higher melting point material than the wearing element.

17. The method of claim 15, wherein the wearing element is made of a higher melting point material than the structure element.

18. A method for making a device using a single forming device to form at least two elements, comprising the steps of:
a) molding a first element with a first melting point at a first temperature above the first melting point in the single forming device; and
b) after step a), molding a second element with a second melting point lower than the first melting point at a second temperature above the second melting point in the single forming device, wherein all of the surfaces of the first element contacting the second element are kept at a temperature below the first melting point.

19. The method of claim 18, further comprising the steps of:
c) between steps a) and b), cooling the first element to a third temperature below the first melting point in the single forming device, such that the first element solidifies; and
d) after steps a), b) and c), cooling the second element to a fourth temperature below the second melting point in the single forming device, such that the second element solidifies.

20. The method of claim 18, wherein the first element is a structure element comprising a top surface spanning a first end and a second end of the structure element, the top surface having a predetermined thickness; and the second element is a wearing element having a first surface and a second surface, the first surface disposed to engage a chain, the second surface being physically bonded with the top surface of the structure element with allowance for relative movement between the top surface of the structure element and the second surface of the wearing element.

21. The method of claim 18, further comprising the step of extending a set of connecting elements of the wearing element completely through a set of openings of the structure element during the single molding cycle.

22. The method of claim 18, wherein the second element is a structure element comprising a top surface spanning a first end and a second end of the structure element, the top surface having a predetermined thickness; and the first element is a wearing element having a first surface and a second surface, the first surface disposed to engage a chain, the second surface being physically bonded with the top surface of the structure element with allowance for relative movement between the top surface of the structure element and the second surface of the wearing element.

23. The method of claim 18, wherein the wearing element and the structure element are able to move with respect to each other in response to thermal expansion and contraction.

24. The method of claim 18, wherein the device is a chain tensioner.

25. The method of claim 18, wherein the device is a chain guide.

26. The method of claim 18, wherein the first element and the second element are not thermally bonded to each other.

27. The method of claim 18, wherein the first element and the second element are not chemically bonded to each other.

28. The method of claim 18, wherein there is slidability between the first element and the second element.

29. A device used with a chain comprising:
a) a structure element having a first end and a second end, the structure element comprising a top surface spanning the first end and the second end, the top surface having a predetermined thickness; and
b) a wearing element having a first surface and a second surface, the first surface disposed to engage a chain, the second surface being physically bonded with the top surface of the structure element with allowance for relative movement between the top surface of the structure element and the second surface of the wearing element;
wherein the top surface of the structure element includes a plurality of openings disposed to receive a plurality of connecting elements of the wearing element, wherein the connecting elements protrude from the second surface of the wearing element and at least a portion of each of the connecting elements extend completely through the openings; and
wherein the openings are larger than the connecting elements thereby allowing for relative movements between the structure element and the wearing element;
wherein the structure element and the wearing element are made of materials with dissimilar melting points.

30. The device of claim 29, wherein the material of the structure element has a higher melting point than the material of the wearing element.

31. The device of claim 29, wherein the material of the wearing element has a higher melting point than the material of the structure element.

32. The device of claim 29, wherein the wearing element and the structure element are able to move with respect to each other in response to thermal expansion and contraction.
